(19) United States
(12) Patent Application Publication
(10) Pub. No.: US 2011/0220097 A1
(43) Pub. Date: Sep. 15, 2011

(54) MIRROR

(75) Inventors: Lionel Ventelon, Jumet (BE); Olivier Bouesnard, Jumet (BE)

(73) Assignee: AGC Glass Europe, Bruxelles (Watermael-boitsfort) (BE)

(21) Appl. No.: 13/058,215

(22) PCT Filed: Aug. 10, 2009
(86) PCT No.: PCT/EP2009/060345

§ 371 Date: May 27, 2011

(30) Foreign Application Priority Data
Aug. 11, 2008 (EP) 08162133.6

(51) Int. Cl. F24J 2/16; G02B 5/08

(52) U.S. Cl. 126/684; 359/850

(57) ABSTRACT

Mirror assemblies according to the present invention comprise a mirror (1) and a facing panel (2) with a sealed gas space (5) therebetween. The mirror (1) may be a mirror comprising a glass substrate (10), a silver coating layer (11) and at least one paint layer (12), or a mirror comprising an organic mirror film (14) bonded to a substrate (13). In the case of a glass mirror, the at least one paint layer (12) faces the sealed gas space (5) and in the case of a mirror comprising an organic mirror film (14), the mirror film faces the sealed gas space (5).

This invention relates to mirrors, in particular for use as solar energy reflectors.

The mirrors of this invention may be used as reflectors in solar energy or heating installations, for example concentrating solar power plants. Such installations use the solar energy to generate heat, which may be converted into electricity or used for steam production. Concentrating solar power plants wherein mirrors according to the present invention may be used comprise, for example, parabolic trough power plants, central tower power plants (also called heliostat power plants), dish collectors and Fresnel reflector power plants. Mirrors assemblies according to the present invention may be used in such installations as flat or curved mirrors.

Solar energy reflectors may be produced either using a self-supporting glass mirror or by forming a laminate comprising a thin glass mirror or a mirror film bonded to a supporting sheet. When using glass mirrors, high reflectivity for the mirror may be obtained if it is thin, so that minimal solar energy is absorbed when passing through the glass substrate of the mirror. However thin glass mirrors may be poor in terms of mechanical resistance, therefore it is generally necessary to laminate them on a supporting substrate, for example a metallic sheet. Alternatively, organic mirror films (highly reflective, glass-free, polymer-based films or silvered acrylic films, for example) are commercially available and may be adhered to a substrate for forming a solar energy reflector.

Mirrors for solar energy reflectors require good ageing properties, for example:

good corrosion resistance: progressive corrosion of portions of the mirrors may reduce the total reflective surface of a concentrating solar power plant and thus the yield of the plant;

good mechanical resistance: solar energy reflectors are often placed in desert environments, where wind and/or sand abrasion may be a problem in particular for organic mirror films;

good resistance to ultraviolet degradation: reflectance of the mirrors, in particular energy reflectance, generally decreases over time under UV radiation.

A small reduction in mirror reflectance may be significant to the overall efficiency of a solar power plant. Whilst degraded mirrors may be replaced, this is time consuming and expensive and leads to down time of the plant. Consequently, it would be advantageous to reduce the loss in reflectance of the mirrors over time.

According to one aspect, the present invention provides a mirror assembly as defined by claim 1. Other claims define preferred and/or alternative aspects of the invention.

The mirror assembly according to the invention comprises a mirror and a facing panel with a sealed gas space therebetween. By facing panel, we mean herein a panel arranged facing the mirror, i.e. arranged so as to face the mirror in a spaced relationship. The mirror is selected from the group consisting of (a) a mirror (herein called “glass mirror”) comprising a glass substrate, a silver coating layer provided at a surface of the glass substrate and at least one paint layer covering the silver coating layer, and (b) a mirror comprising an organic mirror film bonded to a substrate. In the case of a glass mirror, the at least one paint layer faces the sealed gas space and in the case of a mirror comprising an organic mirror film, the mirror film faces the sealed gas space.

The invention provides a mirror assembly, for example for solar energy reflectors, which better maintains its level of reflectance when exposed to UV radiation; in addition, this mirror structure provides a resistance to corrosion and/or a mechanical resistance which is as good as or better than that of known mirrors for solar energy reflectors.

We have found that by arranging the mirror in a sealed, substantially hermetic, assembly, the decrease of its luminous reflectance and energetic reflectance under exposure to UV radiation may be reduced. This may be particularly true when the sealed gas space is in a dry state. Therefore, preferably, the sealed gas space has a dew point temperature of less than 0° C. This means that substantially no condensation appears in the sealed gas space when the assembly is placed in an environment undergoing temperatures above 0° C. Solar energy reflectors may however be placed in environment where temperatures, particularly during the night, may be below freezing. It may thus be preferable for the sealed gas to have a dew point temperature of less than −10° C., more preferably less than −20° C. or less than −30° C.

The sealed gas space may be filled with a gas, for example air, argon, nitrogen or a mixture of two or more of these; it may be a low pressure space having a pressure less than atmospheric pressure.

Advantageously, the assembly comprises a desiccant. Such desiccant may be present in a spacer provided between the mirror and the facing panel, for example in a peripherally extending spacer. Alternatively, it may be present in the sealed gas space itself.

Preferably, the facing panel of the mirror assembly is a glass sheet, a metallic sheet or a composite sheet. For example it may be made of steel, stainless steel, galvanised steel, painted steel, aluminium, or plastic. Advantageously, the substrate of the mirror and the panel are of the same material, so that their expansion coefficients are similar and internal stresses in the mirror assembly are minimised when the assembly is subjected to temperature changes. The thickness of the panel is preferably between 0.1 and 6 mm.

In one preferred embodiment of the invention, the mirror included in the mirror assembly is a glass mirror (i.e. a mirror comprising a glass substrate, a silver coating layer provided at a surface of the glass substrate and at least one paint layer covering the silver coating layer) and the at least one paint layer faces the sealed gas space.

Preferably, the glass substrate of such a glass mirror is made of extra-clear glass, i.e. a glass with a total iron content expressed as Fe₂O₃ of less than 0.02% by weight. Extra-clear glass is often used in solar energy reflectors as it favours a good energetic reflectance value for the reflector; transmission of UV radiation through extra-clear glass is however greater than through ordinary clear glass. The present invention is therefore particularly applicable to those embodiments where extra-clear glass is used, minimising degradation of the reflector properties due to exposure to UV radiation.

Mirrors having a protective layer of copper or copper-free mirrors may be used. Mirrors without a copper layer are preferred, in particular for their environmental benefits. Such mirrors are for example disclosed in U.S. Pat. No. 6,565,217.

The at least one paint layer applied over the silver layer of a glass mirror is preferably lead-free or substantially lead-free. This may have environmental benefits. Substantially lead-free means herein that the proportion of lead in the paint is significantly less than the proportion of lead in leaded paints conventionally used for mirrors. The proportion of lead in a substantially lead-free paint layer as herein defined is less than 500 mg/m², preferably less than 400 mg/m², more preferably less than 300 mg/m². The proportion of lead in a lead-free paint layer as herein defined is less than 100 mg/m², preferably less than 80 mg/m², more preferably less than 60 mg/m². Paints used herein may be, for example, acrylic, epoxy, or alkyd-based.

Advantageously, the total thickness of the mirror may be greater than 0.9 mm or 1.1 mm; it may be less than 2 mm or 1.5 mm; it is preferably about 0.95 or 1.25 mm. Such thin and flexible mirrors may be used in applications were curved reflectors are needed. When flat reflectors are used, the total thickness of the mirror may be greater than 2 mm or 2.5 mm; it may be less than 6 mm or 5 mm.

The silver and paint layer(s) of the mirror may be edge-deleted or the mirror may be edge-worked, for example by grinding; the seal of the mirror assembly may cover the edges of the silver layer and help protect the mirror against edge corrosion. Edge-deletion of the paint may be advantageous to avoid or limit passage of gas and/or moisture through the paint, which may be porous.

A plastic film, e.g. a 40-50 μm thick polypropylene film, may be applied to the painted side of the glass mirror. If the mirror is broken, the glass splinters adhere to the plastic film. This may be advantageous for safety reasons and may facilitate the replacement of the broken mirror. Edge-deletion of the plastic film may be advantageous to ensure good adhesion of the seal and thus integrity of the mirror assembly.

In an alternative embodiment of the invention, the mirror included in the mirror assembly is an organic mirror film, e.g. a reflective polymer-based film, bonded to a substrate. By “organic mirror film”, we mean herein a film comprising in a major proportion an organic material. The substrate may be metallic (for example made of steel, stainless steel, galvanised steel, painted steel, or aluminium) or made of glass or plastic. The mirror film is advantageously positioned so as to face the sealed gas space; this may help keep its mechanical resistance properties and its adhesion to the substrate.

The mirror and the facing panel may be held in a spaced relationship by one or more spacer(s). The spacer may be a peripherally extending frame. It may comprise a metallic, composite or organic profile which is adhered to the panel and the mirror, towards the periphery of the mirror assembly, i.e. along the length of the edges thereof, similar to known insulating glazing panel arrangements. Alternatively, mirror assemblies according to the invention may comprise a plurality of spacers. These may comprise an array of supporting pillars or fibres, similar to known vacuum glazing panel arrangements, or longitudinally extending cords of a material which is sufficiently resistant to compression to act as a spacer.

In another alternative embodiment, the mirror and the facing panel may partially touch each other leaving a plurality of gas spaces between them. These various gas spaces may result from a surface structure present at the mirror surface facing the sealed gas space or at the panel surface facing the sealed gas space. This surface structure may be formed by ridges in the mirror paint or by using a patterned glass as panel facing the mirror.

The thickness of the sealed gas space is preferably comprised between 0.1 and 20 mm. When the sealed gas space comprises a plurality of gas spaces, these may have a thickness between 10 μm and 0.1 mm. A thin sealed gas space is preferred to reduce mirror deformation. When the temperature of the interpane gas increases it will tend to expand and create deformations in the mirror, especially when the mirror is thin; by limiting the quantity of interpane gas, and thus having a thin sealed gas space, such deformations may be reduced or avoided. Alternatively, an expandable chamber (e.g. a bag) may be provided in fluid communication with the gas space, to absorb volumetric changes of the gas in the gas space, thereby reducing or eliminating deformations in the mirror.

The sealed state of the sealed gas space may be maintained by the presence of a sealing material in the assembly. The sealing material advantageously forms a barrier to the ingress of moisture vapour and/or water in the assembly and may provide mechanical resistance to the assembly. The sealing material may comprise at least one material selected from the group consisting of epoxy materials, acrylate materials, butyl materials, polyurethane materials, polysulfide materials, acrylic materials and silicone materials. Silicone materials according to the present invention may be MS polymers. Preferably the sealing material comprises at least an adhesive material. For mirror assemblies under vacuum, the sealing material may comprise inorganic, e.g. metallic, sealing means. When a material sensitive to UV radiation is used in the sealing material (e.g. epoxy or polyurethane), it may be advantageous for the sealant to be protected against UV radiation. Advantageously, the sealing material has a moisture vapour transmission rate (MVTR) equal to or less than 30 g/m².24 h for a 2 mm thick membrane, preferably equal to or less than 20 g/m².24 h. This may help keep the sealed gas space in a dry state.

Advantageously, the sealing material may provide both functions of hermetically sealing off the sealed gas space and spacing the mirror and the panel from each other, by using for example a structural material as sealing material. This may avoid the use of a frame or pillars.

The mirror assembly may be flat or curved. A curved mirror assembly may be used as curved solar energy reflector.

In a method to obtain a curved mirror assembly, a thin (e.g. between 0.9 mm and 2 mm), originally flat, glass mirror may be assembled with a curved panel (for example a bent glass sheet); the thin glass mirror will follow the shape of the curved panel and the sealed gas space will be maintained with the help of the spacer(s) and/or seal. When the curved mirror assembly is used as a curved solar energy reflector, the reflected sun rays are focused on a collector, and, in use, the assembly should preferably not distort in a way where the reflected sun rays would be focused out of the collector. Therefore, the curve of the assembly and the seal composition and dimensioning are preferably selected so that the focus point of the reflected sun rays remains substantially always on the collector, knowing that:

the mirror in the assembly is subjected to elastic return forces tending for the mirror to recover its originally flat shape, and

the assembly, in use, may be subjected to external forces (e.g. a wind of 80 km/h blowing on the assembly).

We have found for example, that a mirror assembly wherein the spacer is exclusively formed by a peripherally extending glue cord may show only acceptable shape deviations, avoiding the focus point of the reflected sun rays to be out of the collector. On the contrary, although we could have thought that by better maintaining the mirror and the panel together, we would have limited the shape deviations of the assembly when subjected to internal elastic return forces and/or external forces, we have surprisingly found, that when a too great proportion of the mirror and panel surfaces are glued together, the assembly may show greater shape deviations.

In another method to obtain a curved mirror assembly, both the mirror and the panel may be bent separately, then assembled. A flexible spacer, e.g. Swiggle Seal or Super Spacer®, may be used to hold the mirror and the panel spaced from each other.

Alternatively, to manufacture a curved solar energy reflector, a flat thin mirror assembly according to the present invention may be bent.

According another aspect, the present invention provides a solar energy reflector as defined by claim 11.

Embodiments of the invention will now be described, by way of example only, with reference to FIGS. 1 to 7 and to examples 1 and 2, along with comparative example 1.

FIGS. 1 to 7 are schematic cross-sections of mirror assemblies according to the invention. Figures are not drawn to scale.

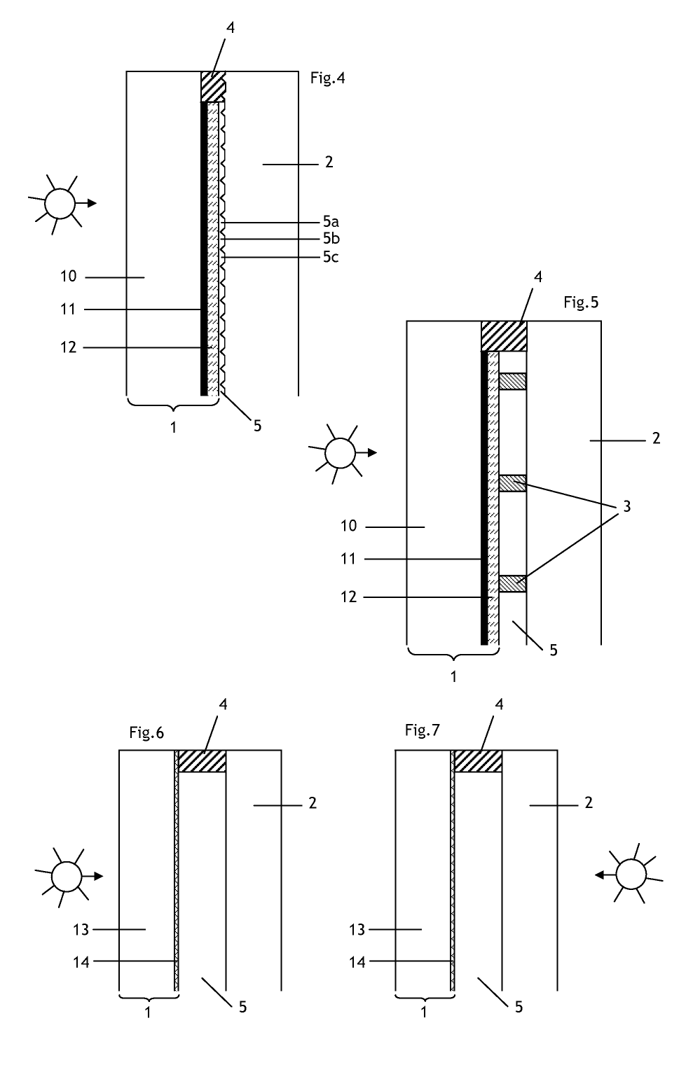

FIGS. 1 to 5 show mirror assemblies incorporating a glass mirror. In FIGS. 1 to 3, the spacer is a peripherally extending frame; in FIG. 4, the sealed gas space is made up of a plurality of individual gas spaces; in FIG. 5, the sealed gas space is evacuated and the spacers form an array of pillars.

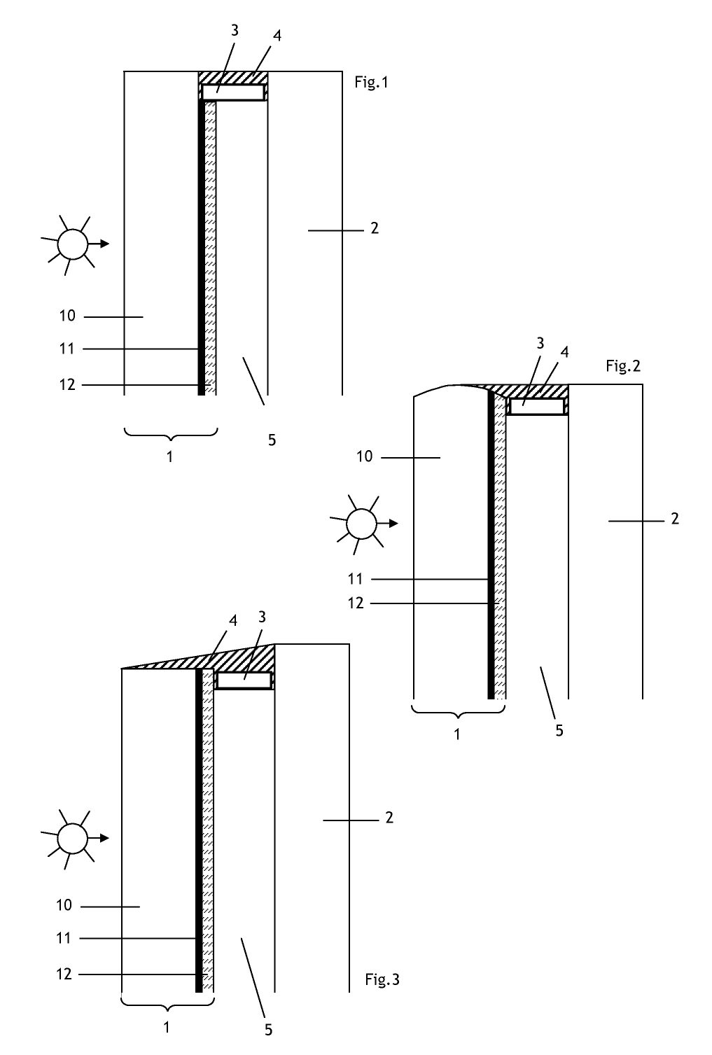

FIG. 1 shows a mirror (1) with a glass substrate (10) (which may be extra-clear glass) supporting a silver layer (11) covered with a paint layer (12). The mirror is assembled with a panel (2) which may be a glass sheet, a metallic sheet or a composite sheet, by means of a spacer (3) and a sealing material (4). The silver and paint layers are edge-deleted so that the sealing material adheres to both the mirror glass substrate and the panel, and covers the edge of the silver layer for a better edge corrosion resistance of the mirror. In FIG. 2, the mirror has been edge-worked by grinding and the sealing material covers the edge of the silver layer. In FIG. 3, the panel is slightly greater in surface area than the mirror and the sealing material extends on the edges of the mirror; therefore, the sealing material covers the edge of the silver layer although the mirror has not been edge-worked.

In FIG. 4, a plurality of gas spaces (51, 52, 53, . . . ) are formed between the mirror and the panel due to the presence of a texture at the surface of the patterned glass sheet used as the panel. The sealed gas space, made of these various individual gas spaces, may be evacuated.

FIGS. 6 and 7 show mirror assemblies incorporating a mirror (1) comprising an organic mirror film (14) bonded to a substrate (13). Examples of mirror films are ReflecTech® mirror films or ECP-305+ and ECP-300 made by 3M®. The sealing material acts here as sealant and spacer. In FIG. 6, the sun rays pass through the mirror substrate (13) and are reflected by the mirror film (14); the mirror substrate (13) may be glass, preferably extra-clear glass and the facing panel may be a glass sheet, a metallic sheet or a composite sheet. In FIG. 7, the sun rays pass through panel (2) and the sealed gas space (5) and are reflected on the mirror film (14); the mirror substrate (13) may be a glass sheet, a metallic sheet or a composite sheet and the facing panel may be glass, preferably extra-clear glass.

Examples 1 and 2 are mirror assemblies according to the present invention. They comprise a mirror of the type MNGE®, a mirror with no copper layer commercialised by AGC Flat Glass Europe SA, comprising a glass substrate (4 mm thick clear float glass), a silver coating layer and two layers of alkyd-melamine paints. The silver and paint layers are edge-deleted over 1 cm along the four edges of the mirror. The mirror is assembled with a 4 mm thick clear glass sheet by means of a peripherally extending steel frame and a peripherally extending seal comprising butyl-rubber and silicone. The paint layers of the mirror face the sealed gas space and the mirror glass substrate faces the exterior of the assembly. The sealed gas space is 12 mm thick and the seal has a thickness of 3.5 mm. In example 1, the sealed gas space is filled with air; in example 2, it is filled with argon.

Comparative example 1, not in accordance with the invention, is a MNGE® mirror which is not assembled.

Examples 1 and 2 and comparative example 1 were subjected to UV radiation in a Q panel test, during various periods of time. Results of luminous reflectance (LR) and energetic reflectance (ER) are given in Table I. Haze was also controlled.

TABLE I

| | | LR (illuminant D10) | | | | | | ER measured according to ISO 9050-2003 (RE90.03) | | | | | |
|---|---|---|---|---|---|---|---|---|---|---|---|---|---|
| | | initial | | UV dose: 60 kW/m²/h | | UV dose: 120 kW/m²/h | | initial | | UV dose: 60 kW/m²/h | | UV dose: 120 kW/m²/h | |
| | | t = 0 | | t = 2500 h | | t = 5000 h | | t = 0 | | t = 2500 h | | t = 5000 h | |
| | | LR [%] | haze | LR [%] | haze | LR [%] | haze | ER [%] | haze | ER [%] | haze | ER [%] | haze |
| Exam- | air | 92.53 | no | 91.70 | no | 91.93 | acceptable | 84.66 | no | 84.81 | no | 84.98 | acceptable |
| ple 1 | | | | | | | | | | | | | |
| Exam- | argon | 92.12 | no | 91.64 | no | 91.71 | acceptable | 84.20 | no | 84.73 | no | 84.81 | acceptable |
| ple 2 | | | | | | | | | | | | | |
| Comp. | — | 92.31 | no | 91.52 | no | 89.55 | unacceptable | 84.49 | no | 84.53 | no | 82.91 | unacceptable |
| Ex. 1 | | | | | | | | | | | | | |

It can be seen from Table I that by assembling a mirror in an assembly according to the present invention, luminous and energetic reflectances may be kept higher after exposure to UV radiation.

1. A mirror assembly, comprising:
a mirror and a facing panel with a sealed gas space therebetween;
wherein the mirror is selected from the group consisting of:
(a) a mirror comprising
a glass substrate,
a silver coating layer provided at a surface of the glass substrate and
at least one paint layer covering the silver coating layer,
wherein the at least one paint layer faces the sealed gas space; and
(b) a mirror comprising
an organic mirror film bonded to a substrate,
wherein the mirror film faces the sealed gas space.

2. A mirror assembly according to claim 1, wherein the sealed gas space has a dew point temperature of less than 0° C.

3. A mirror assembly according to claim 1, wherein the sealed gas space is a low pressure space having a pressure less than atmospheric pressure.

4. A mirror assembly according to claim 1 further comprising a desiccant.

5. A mirror assembly according to claim 1, wherein the panel is selected from the group consisting of a glass sheet, a metallic sheet and a composite sheet.

6. A mirror assembly according to claim 1, wherein the mirror and the panel are held in a spaced relationship by at least one spacer.

7. A mirror assembly according to claim 1, wherein the sealed gas space comprises a plurality of gas spaces.

8. A mirror assembly according to claim 1, wherein the sealed gas space is maintained in a sealed state by a sealing material comprising at least one material selected from the group consisting of an epoxy material, an acrylate material, a butyl material, a polyurethane material, a polysulfide material, an acrylic material and a silicone material.

9. A mirror assembly according to claim 8, wherein the sealing material has a moisture vapour transmission rate (MVTR) equal to or less than 30 g/m².24 h for a 2 mm thick membrane.

10. A mirror assembly according to claim 1, wherein the assembly has a curved shape.

11. A solar energy reflector, comprising: the mirror assembly according to claim 1.
